(19) United States
(12) Patent Application Publication
(10) Pub. No.: US 2016/0333614 A1
(43) Pub. Date: Nov. 17, 2016

(54) MOTOR VEHICLE DOOR LOCK

(71) Applicant: KIEKERT AG, Heiligenhaus (DE)

(72) Inventor: Thorsten Bendel, Oberhausen, North Rhine-Westphalia (DE)

(21) Appl. No.: 15/033,738

(22) PCT Filed: Oct. 13, 2014
(86) PCT No.: PCT/DE2014/100358

§ 371 Date: Jun. 29, 2016

(30) Foreign Application Priority Data
Nov. 4, 2013 (DE) 10 2013 112 122.5

(51) Int. Cl. E05B 77/02; E05B 17/10; E05B 53/00; E05B 85/10; E05B 79/20; E05B 79/22; E05B 81/06; E05B 81/14; E05B 77/12; E05B 77/54

(52) U.S. Cl. CPC E05B 77/02; E05B 77/12; E05B 17/10; E05B 53/001; E05B 77/54; E05B 79/20; E05B 79/22; E05B 81/06; E05B 81/14; E05B 85/10; E05B 85/107

(57) ABSTRACT

The invention relates to a motor vehicle door lock having a locking mechanism essentially consisting of a rotary latch and a pawl, and having an emergency opening handle for emergency actuation. The locking mechanism is first moved into its pre-locked position by means of a motor before the emergency actuation handle can be activated.

### BACKGROUND

The invention relates to a motor vehicle door latch with a locking mechanism predominantly comprising a catch and a pawl and with an emergency opening handle for emergency activation.

Motor vehicle door latches of the stated type are already known from WO 2004/079137 A2. It is envisaged here to provide an emergency activation handle for manual opening in the case of a blocked exposure process of motor vehicle doors in the case of motor vehicle doors which are frozen or contorted due to accidental damage. Such an emergency activation handle is proposed, for example, in the form of a folding or pulling handle. Thus, a greater force can be applied via the emergency activation handle in order to open the relevant motor vehicle door.

However, problems can occur if the motor vehicle door latch is still in a bolted or unbolted main ratchet position, in an accident, for example. The door is then locked shut or shut. In these cases, the motor vehicle door can often not be opened with an emergency activation handle, even with great exertions of force. This is where the invention is used.

### SUMMARY

The invention is based on the technical problem of further developing a motor vehicle door latch of the design described at the start in such a way that the emergency activation handle can be successfully activated at any time where possible, especially in the case of accidents.

In order to solve this technical problem, in the case of a class-specific motor vehicle door latch the invention proposes that the locking mechanism is initially mechanically moved into its preratched position before the emergency activation handle can be activated.

If the locking mechanism is initially moved mechanically into its pre-ratchet position before the emergency activation handle can be activated, it is ensured that a locking mechanism which is still in the main ratchet position is not worked against during activation of the emergency activation handle. Thus, the catch assumes an intermediate state with the pre-ratchet position from the main ratchet position. Here, not only is a pre-ratchet position provided for during closure of the motor vehicle door, but also a pre-ratchet position during emergency opening. In the latter case, the catch is transferred from the main ratchet position (motor vehicle door shut or locked shut) into the pre-ratchet position (slightly exposed due to the elastic effect of door seals, but door still blocked) by means of a motor. On the contrary, transfer into a completely open position of the catch is not useful because the doors can be ripped off in the case of accident due to the force of the impact.

The advantage of the pre-ratchet position compared to the main ratchet position is that the door can usually be opened more easily in the case of frozen/stuck/contorted components. It often then only needs a tug to open the door.

Considerable forces can be applied sometimes via door handles. But in the case of electric latches according to the invention there is no mechanical connection between the door handle and the motor vehicle door latch. In certain situations, for example in the case of accidents, the motor vehicle door latch does not react to the operator's commands due to a defect. Consequently, the catch remains in the main ratchet position. A whole range of involved elements can be non-functional. Consequently, the door can no longer be opened. These are the electromotor driving the pawl, the electrical cable to the car battery of the electromotor, the element carrying the opening command to the electromotor (for example, a key or a cable). A certain redundancy must be ensured due to the involvement of numerous elements. An activatable emergency activation handle is required which depicts nothing other than mechanical redundancy of the electrical system.

The term “activatable” comprises both passively and also actively activatable emergency activation handles. Active activatibility corresponds to a process in which stored energy ultimately leads to the emergency activation handle being provided to the operator in a certain way. For example, this can be stored elastic energy which projects the emergency activation handle. Active provision is also conceivable by means of an electromotor.

In contrast, passive activatability means that the operator is ultimately responsible himself for the provision. For example, this can occur via folding a ledge up or down.

An activatibility of the emergency activation handle is equally conceivable in which both active and passive activation is necessary. For example, a snap element with stored elastic energy could release a ledge which is then folded down by the operator in order to reach an emergency activation handle lying further inside.

The emergency activation handle initially has the task of bringing the catch from the pre-ratchet position into the open position to enable the door to be opened. To this end, the emergency activation must ultimately strike the pawl, whereby the catch can snap back into the open position. The transfer of the movement from the emergency activation handle to the pawl can occur by means of a rod or a rope, for example. According to the invention it only depends on the pawl releasing the catch.

In the case of handleless vehicle doors, the emergency activation handle can furthermore also be designed in such a way that great forces can be transferred from the emergency activation handle to the door. For example, it is conceivable that a relevantly dimensioned rope pulls on the pawl with a first smaller branch. This smaller branch is ideally dimensioned in such a way that it can also loosen slightly jammed or tilted pawls, but rips on a target ripping point in the case of even greater forces. Thus, a larger branch of the rope is released which can transfer far greater forces. These forces strike the door panel directly and thus enable the door to be opened wide.

If assumption of the pre-ratchet position is triggered by a sensor signal, the intermediate state of the pre-ratchet position after the main ratchet position can be associated with a certain sensory parameter. Where the sensor signal involves the signal of an acceleration sensor, especially a crash sensor, the intermediate state of the pre-ratchet position after the main ratchet position can be connected to an accident, in particular.

Acceleration sensors are very quickly able to evaluate a relevant situation as an accident. In the present case, this speed advantage is utilized by the locking mechanism being mechanically moved into its unbolted position at an earlier time of the accident. At this earlier time it must be assumed that the vehicle has not yet been contorted and accordingly many parts of the motor vehicle door latches are intact. Fractions of seconds later it must not absolutely be assumed. Consequently, the crash signal is of considerable help for a functioning emergency activation.

Preferably the emergency activation handle can be transferred into a position which can be activated by the operator dependent on the sensor signal. Also, as the unbolted position is advantageously assumed dependent on a sensor signal, a position of the emergency activation handle which can be activated by an operator is advantageous which is assumed dependent on the sensor signal. Here, too, the speed advantage helps to set the course in a timely manner for a provision of the emergency activation handle.

The activatable position of the emergency activation handle can correspond to an exposed position of a motor vehicle surface and/or a position accessible via a cover. The term “motor vehicle surface” means proportionally large surfaces, such as window surfaces or the panel surfaces of a door. In contrast, for example, door handles, external mirrors or also only decorative trims are located in an exposed position.

However, the emergency activation handle can also be accessible via a cover which is not exposed. Examples include decorative components engaged into the motor vehicle surface, window seals, or also covers which are completely invisible under the chassis paint. The term “exposed position” elaborates on whether the emergency activation handle 1 is still in the activatable (i.e. non-activated) position or already in the activated position. In the activated position all emergency activation handles 1 are in an exposed position. However, this does not apply to the activatable position.

Finally, in the case of a door exposed due to a pre-ratchet (exposed position) there is the option of arranging the emergency activation handle on the front surface of the motor vehicle door. The term “front surface” refers to that surface of the door on which the motor vehicle door latch is also located. The advantage of this arrangement is that the emergency activation handle is in direct proximity to the motor vehicle door latch and enables a correspondingly simple power transmission system to the motor vehicle door latch. Furthermore, a beneficial lever effect results relative to the door hinge.

If the locking mechanism is moved via an electromotor of the pawl in the pre-ratchet position, the intermediate state of the pre-ratchet position after the main ratchet position can be easily realized. For example, this is possible by the pawl being briefly ventilated, i.e. only lifted for a short time. Consequently, the catch can shoot out but is still caught in its pre-ratchet position again in a timely manner. Another pawl is also conceivable which is controlled via the electromotor of the first pawl or a second electromotor. The position of this second pawl then justifies the intermediate state of the pre-ratchet position after the main ratchet position.

When the emergency activation handle is arranged on a right and/or left and/or rear motor vehicle side, preferably on and/or near a motor vehicle door, the emergency activation handle can be executed via a comparatively simple mechanism. This applies all the more the nearer the emergency activation handle is to the motor vehicle door latch. The term “near” means in particular the components adjacent to the door such as lateral longitudinal beams, external mirrors and door frames. If an emergency activation handle is extremely close to the motor vehicle door latch, a mechanical connection can already be produced by a simple rod. If greater distances are involved, the mechanical connection can be produced via a rope, for example.

The emergency activation handle can at least be activated by at least a hand or at least a finger or at least a foot. Thus, emergency activation handles which can be activated with a hand such as pulling handles, folding levers, concealed handles, external mirrors or ropes are also conceivable. For example, the concealed handles can be located on the inside of a door handle, for example, or also underneath a window seal. External mirrors can be pulled manually forwards, i.e. in the direction of the motor hood, whereby a pulling rope pulls inside the door on the motor vehicle door latch.

Emergency activation handles which can be activated by a finger can be vents or pull rings, for example. Both emergency activation handles are proportionally small and permit advantageous housing. However, emergency activation handles which can be activated by fingers, in particular, are unsuitable for transmitting larger forces.

Emergency activation handles which can be activated with the foot include step edges, step boards or also clamps. These are advantageously arranged at the height of the lateral longitudinal beams and enable the transmission of greater forces.

If the emergency activation handle is preferably designed for greater forces, mechanical imponderabilities can be prevented with regard to door opening in the case of an accident. Often motor vehicle doors are contorted in such a way that they cannot be opened despite the catch being in an open position. However, if these emergency activation handles are designed for greater forces, the probability is greater that the jammed door can be loosened by means of a forceful tug via the emergency activation handle and thus can be ultimately opened. Great forces can be transmitted in particular via emergency activation handles which permit the striking of at least one foot or two hands.

Positional information of the emergency activation handle can be triggered which preferably comprises a signal color and/or a light. The positional information is useful in particular for those people who are rushing to assist a vehicle involved in an accident. The positional information enables rapid recognition of the ability to open. Here a signal color is available, for example red or red-white. Instead of a static signal color, however, a light can also be provided for. A flashing light in particular attracts attention.

Hereinafter, the invention is explained in further detail on the basis of sketches which are only an execution example.

### BRIEF DESCRIPTION OF THE DRAWINGS

FIGS. 1A to 6B emergency activation handles for motor vehicle doors according to the invention.

### DETAILED DESCRIPTION OF THE DRAWINGS

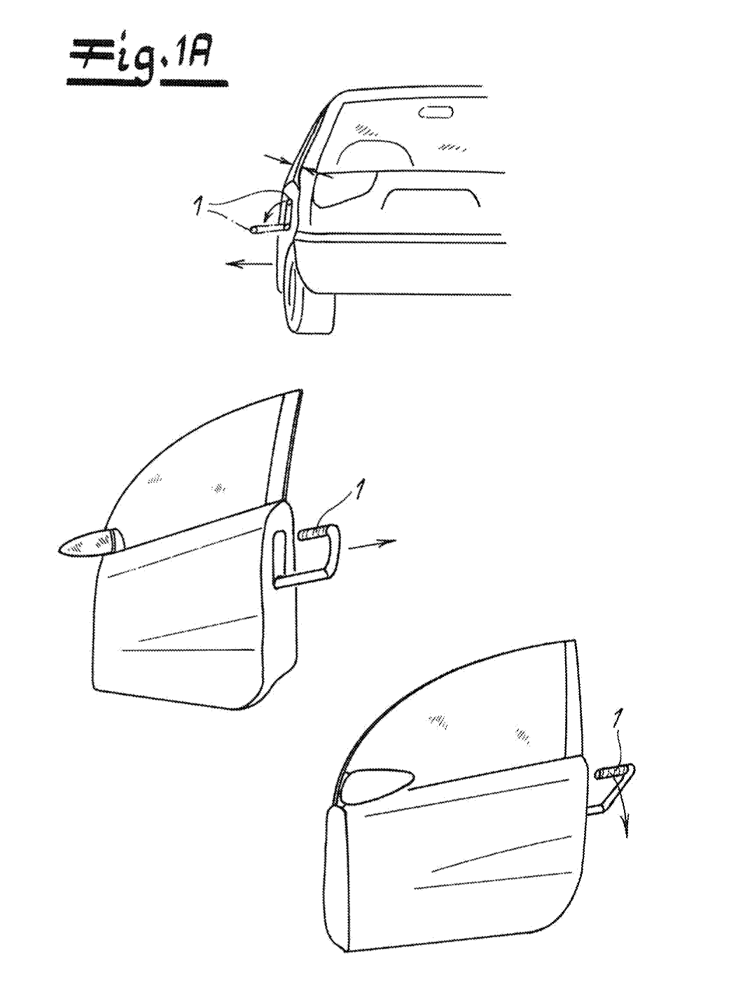

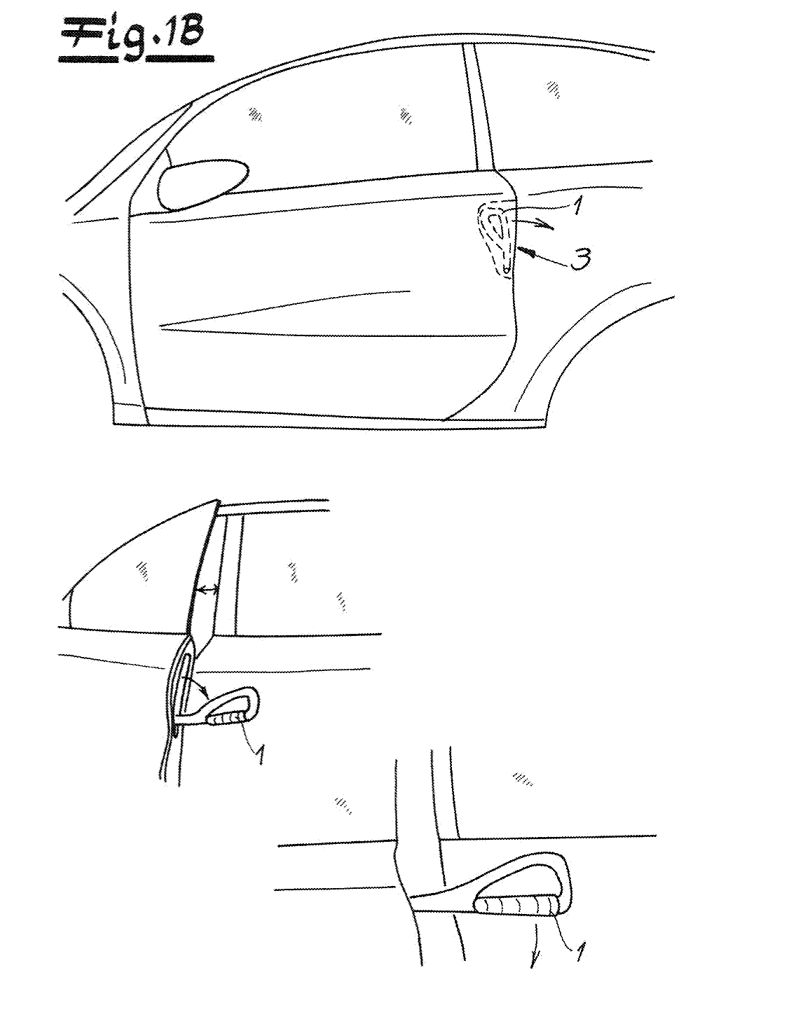

In FIG. 1A a first emergency activation handle 1 of a motor vehicle door is depicted. The motor vehicle door was exposed, for example, following a crash signal by the catch being transferred from the main ratchet position into the pre-ratchet position and simultaneously the door seal having pushed the door as far as possible away from the motor vehicle surface due to its elastic forces. This simultaneously releases the front side of the door upon which the emergency activation handle 1 is arranged.

Preferably also due to a crash signal, the emergency activation handle 1 was transferred from a depressed position corresponding to a cover into an activated position. By folding down to the operator the emergency activation handle 1 is activated and the catch opened. At the same time, the pulling handle folded down to the operator can transfer great forces to the emergency activation handle 1 in order to force open the door if necessary.

FIG. 1B shows an emergency activation handle 1 designed as a folding lever. This functions similarly to the pulling handle from FIG. 1A, with the difference that the folding lever is not pulled outwards, but downwards in order to activate the emergency activation handle 1.

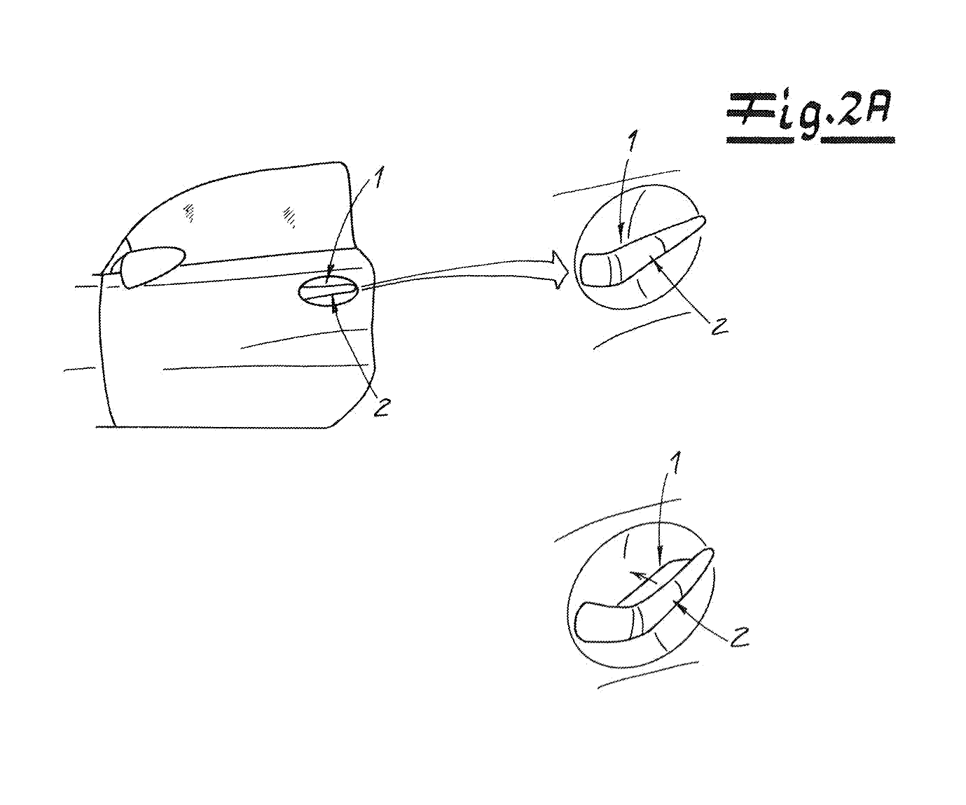

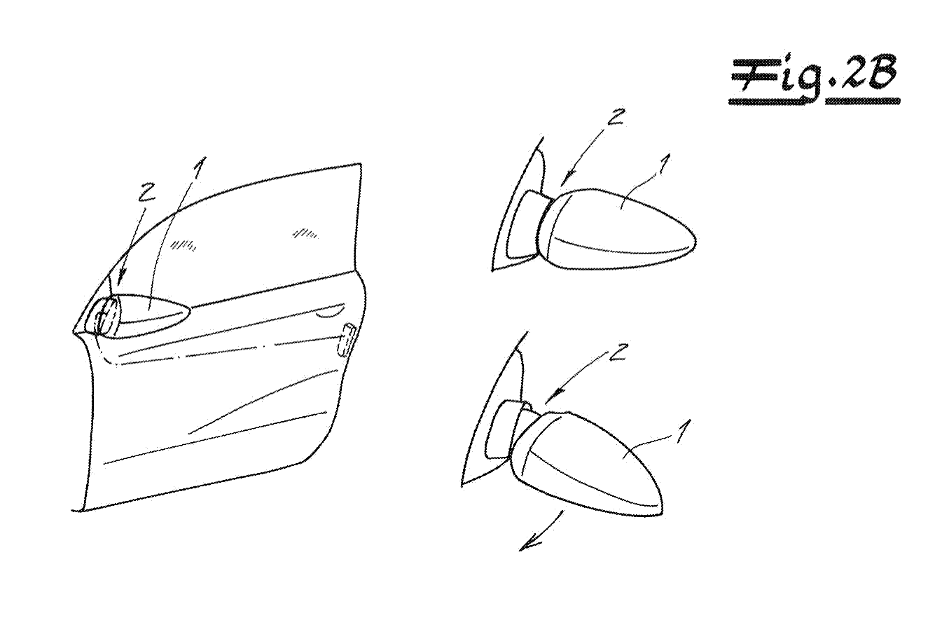

As in FIGS. 1A and 1B the emergency activation handle 1 from FIG. 2A must also be activated manually. The emergency activation handle 1 designed as an internal handle is located inside an external door handle and is concealed to a certain extent. Thus, the external door handle assumes an exposed position 2. In contrast to the solutions from FIGS. 1A and 1B no great force can strike the external door handle via the internal handle. The inside handle of the external door handle is therefore only suitable as an emergency activation for the catch. However, in this case the great forces can be exerted on the external door handle. This is why an emergency activation handle 1 is not necessary in a separately designed form.

The external mirror from FIG. 1B assumes a further exposed position 2 for an emergency activation handle 1. If this is pulled on, for example forwards in the direction of travel, the emergency activation is activated for example via a rope mechanism and the catch is opened. As no great forces can be transferred to open the door via the external mirror, an external door handle is necessary to exert great forces.

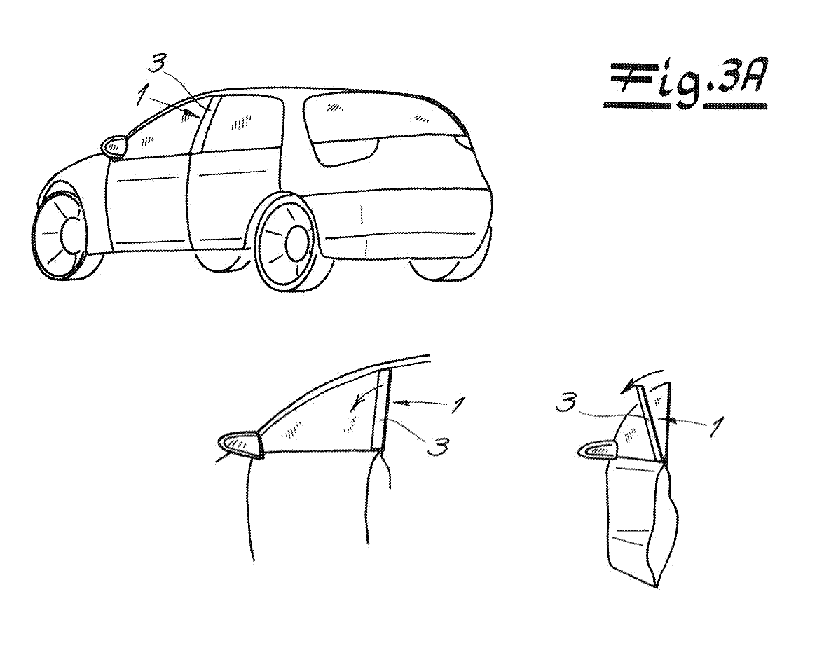

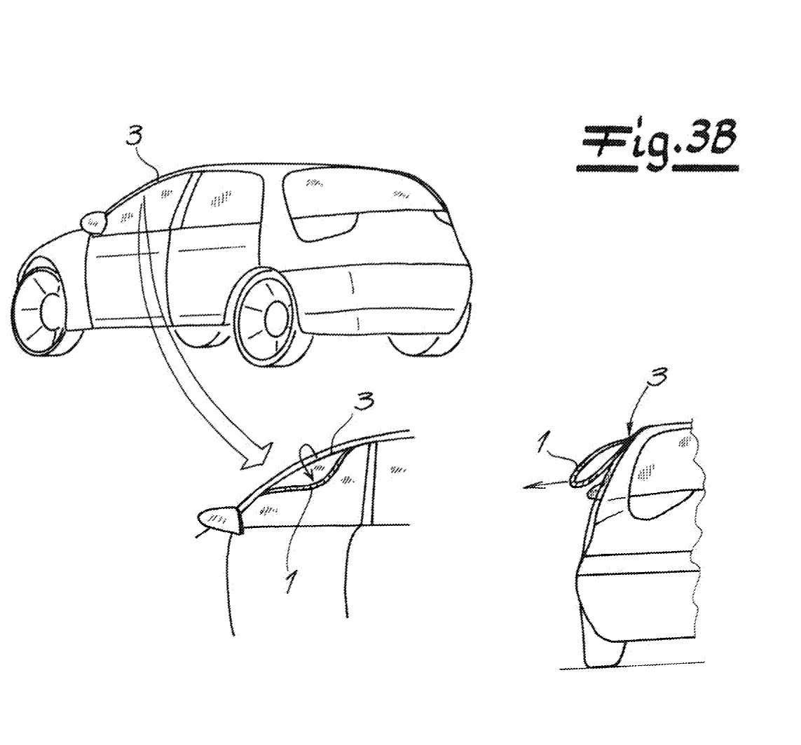

FIG. 3B illustrates an emergency activation handle 1 which is simultaneously a cover 3 in the form of a decorative trim of the B-column, and which is pulled outwards for emergency activation. In this pulled outwards position the emergency activation handle 1 can be well activated accordingly.

As in the previous solutions, FIG. 3B also shows an emergency activation lever 1 which is manually activated. The emergency activation handle 1 illustrated here is a rope which is located in or underneath a window seal. In this case, the window seal corresponds to a cover 3. Here too it must be supposed that the rope can only transfer small forces. Consequently, it is only suitable for the opening of the catch. Consequently, in this case too external door handles are expedient for the transfer of great forces.

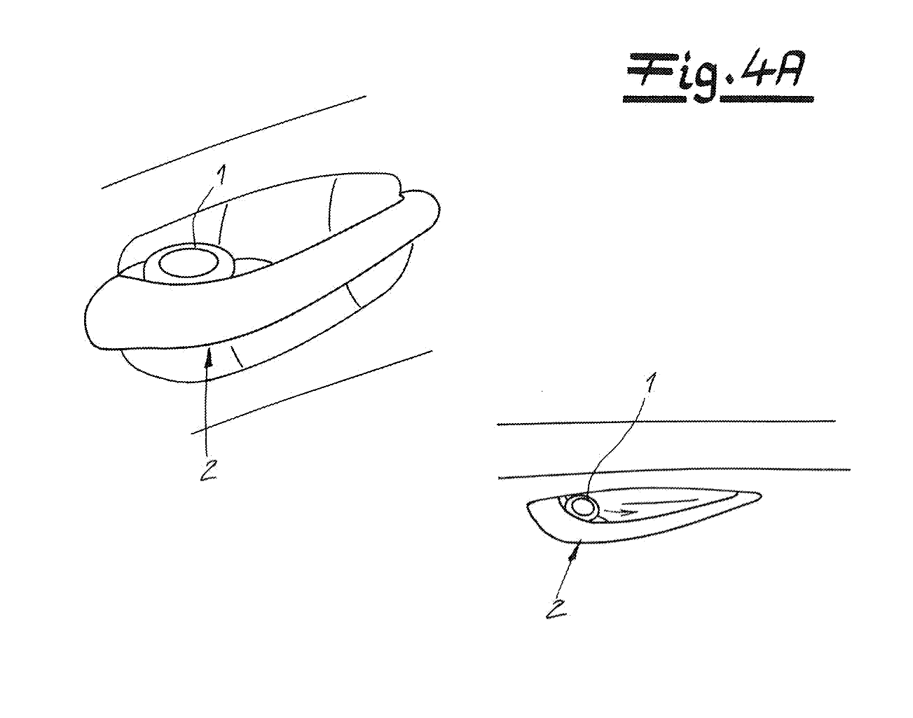

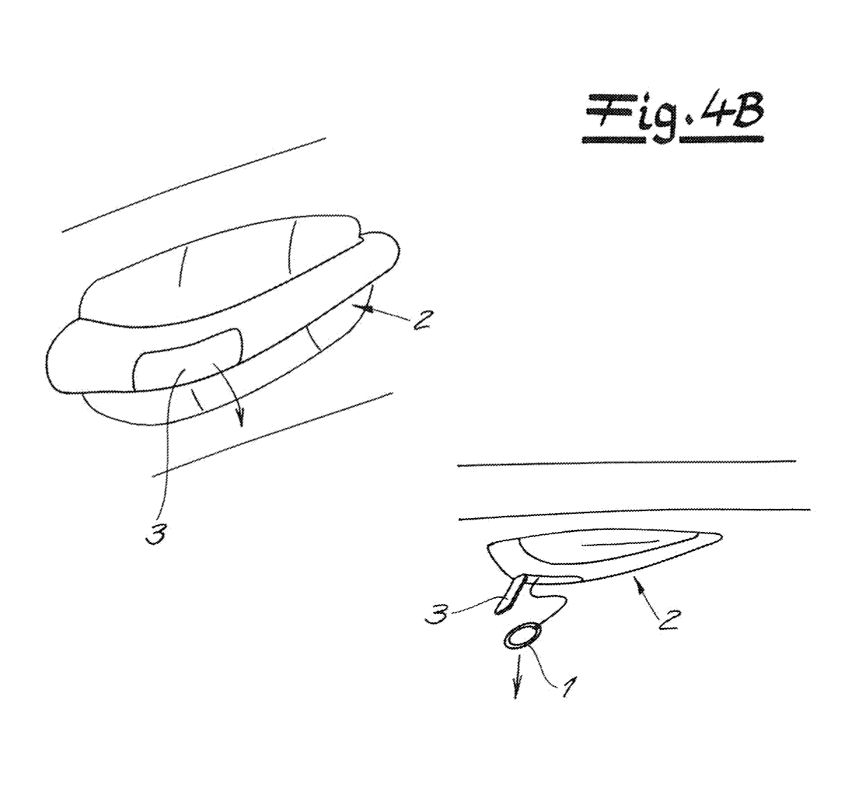

In FIG. 4A the solution deviates from all previous solutions as the emergency activation handle 1 designed as a gun trigger can be activated using a finger. Accordingly, only small forces can be transferred with the gun-trigger emergency activation handle 1. Activation of the external door handle is expedient for transmitting larger forces.

A similar scenario applies to the emergency activation handle 1 designed as a pulling ring in FIG. 4B. The pulling ring is arranged in the exposed position 2 in the form of an external door handle. A cover 3 on the external door handle conceals the pulling ring.

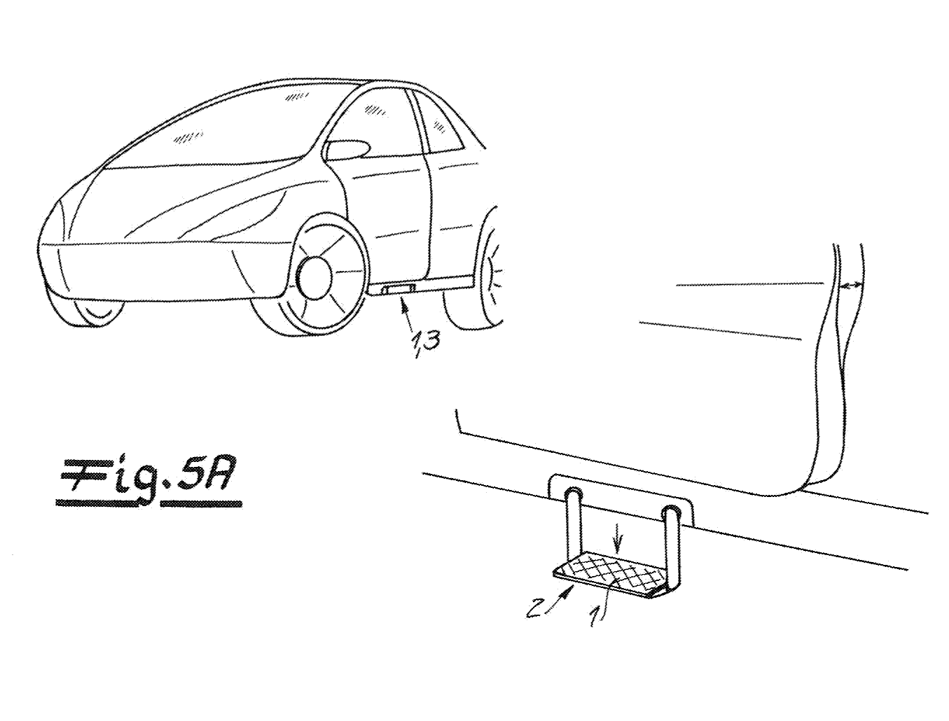

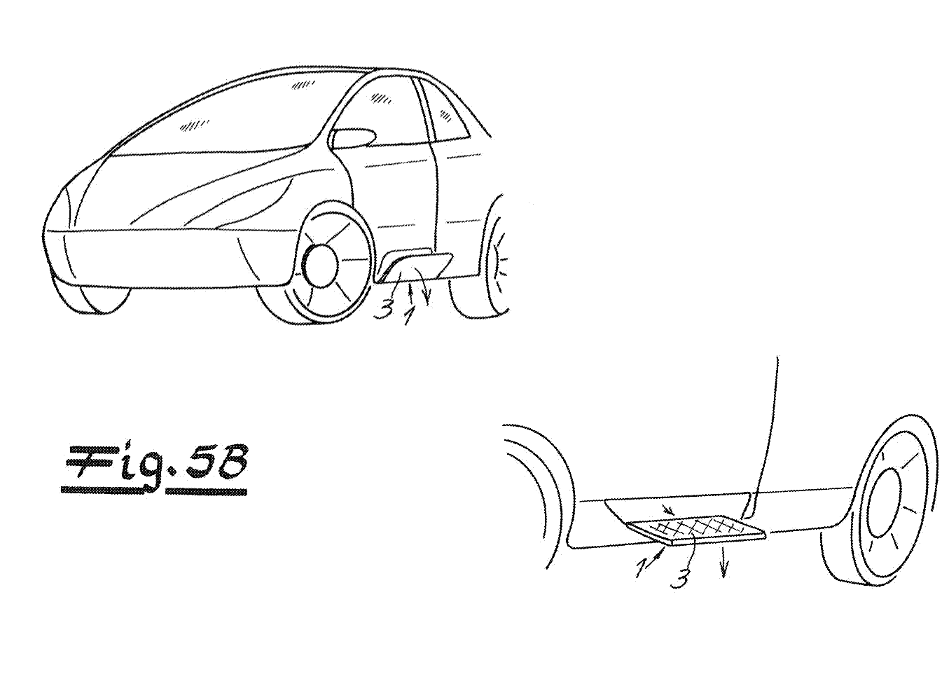

In contrast to the previous solutions, the emergency activation handle 1 in FIG. 5A can be activated with the foot. The emergency activation handle 1 designed as a step edge can, for example, be arranged on the lateral longitudinal beam or also on the underside of a motor vehicle door. The final solution is only possible on exposed doors. Due to the foot activatability greater forces can also be transferred with the step edge. However, these are predominantly aligned downwards. Consequently, ripping open of the motor vehicle door is more difficult.

A similar scenario applies to the emergency activation handle 1 designed as a step board in FIG. 5B. The step board corresponds to a folded down cover 3 which is located in an activated and activatable position due to the folding down.

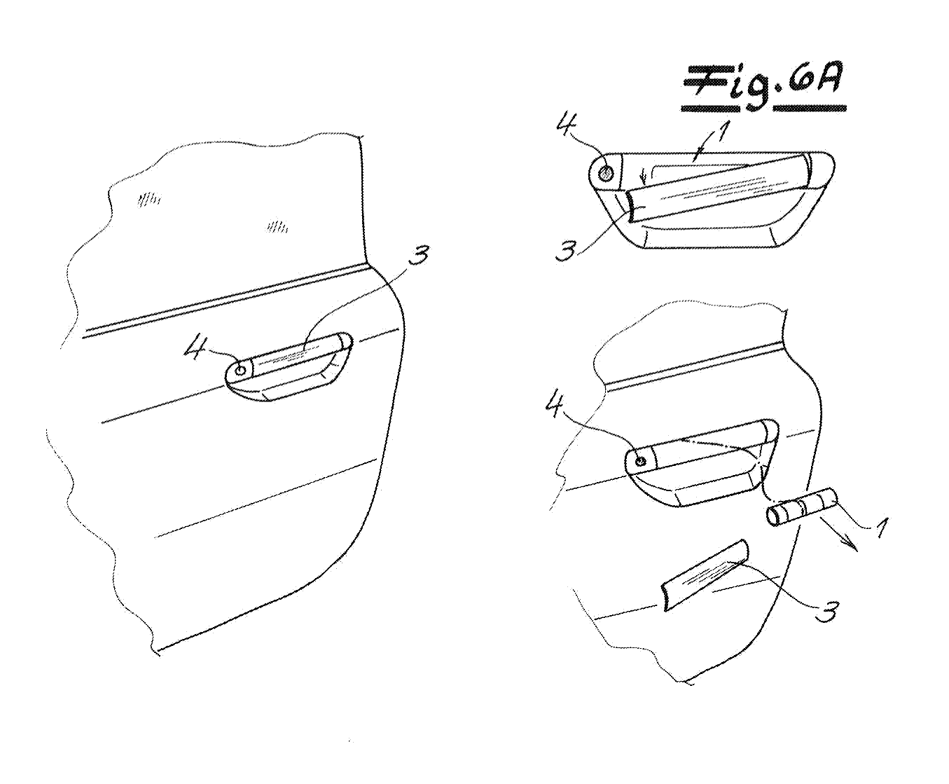

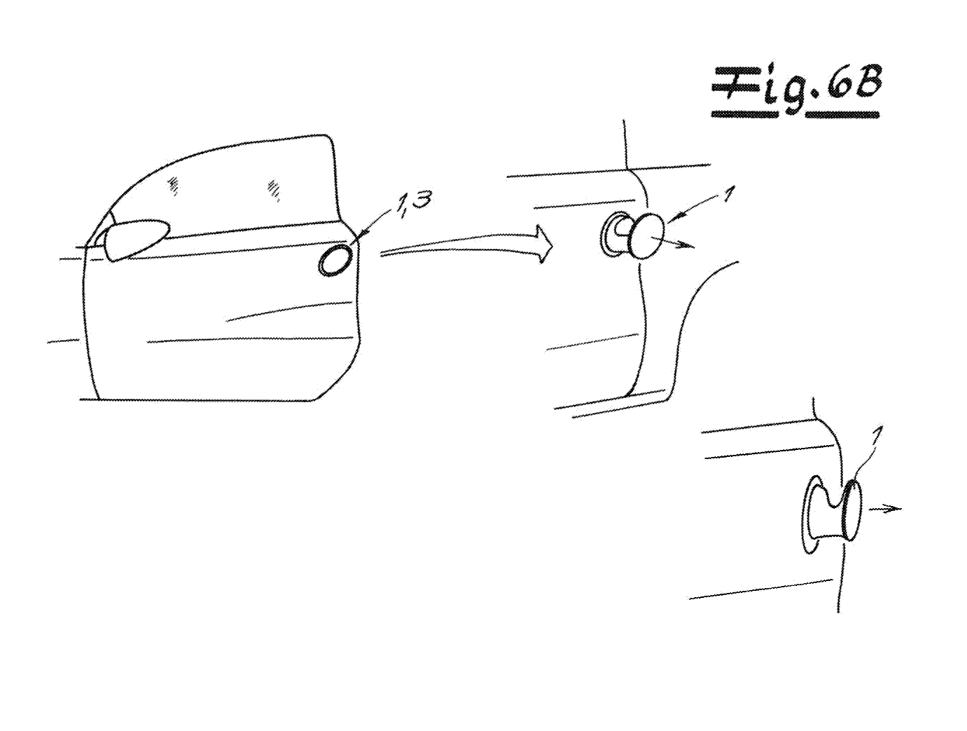

In FIG. 6A an emergency activation handle 1 is depicted in the form of a pulling handle to a rope. A cover 3 conceals the emergency activation handle 1. Furthermore, positional information 4, for example in the form of an LED light, displays the position of the emergency activation handle 1. If a button is pressed on the LED light in this execution example, the cover 3 falls off and releases the emergency activation handle 1.

FIG. 6B shows a button or knob-shaped emergency activation handle 1 which is faced with a cover 3 and protrudes on activation. The activation can occur automatically (actively) or also via an operator (passively). The emergency activation handle 1 is then activated manually on a grip recess by being pulled further outwards.

1. Motor vehicle door latch, with a locking mechanism predominantly comprising a catch and a pawl, and with an emergency opening handle for emergency activation, wherein the locking mechanism is initially moved into its preratched position mechanically before the emergency activation handle can be activated.

2. Motor vehicle door latch according to claim 1, wherein the assumption of the pre-ratchet position is triggered by a sensor signal.

3. Motor vehicle door latch according to claim 2, wherein the sensor signal involves a signal of an acceleration sensor, in particular a crash sensor.

4. Motor vehicle door latch according to claim 3, wherein the emergency activation handle is transferred into a position which can be activated by the operator dependent on the sensor signal.

5. Motor vehicle door latch according to claim 1, wherein the activatable position of the emergency activation handle can correspond to an exposed position compared to a motor vehicle surface.

6. Motor vehicle door latch according to claim 1, wherein the locking mechanism is moved via an electromotor of the pawl into the pre-ratchet position.

7. Motor vehicle door latch, according to claim 1, wherein the emergency activation handle is arranged on a right and/or left and/or rear motor vehicle side.

8. Motor vehicle door latch according to claim 1, wherein the emergency activation handle can be activated by means of at least one hand or at least one finger or at least one foot.

9. Motor vehicle door latch according to claim 1, wherein positional information of the emergency activation handle can be triggered.

10. Procedure for the operation of a motor vehicle door latch, with a locking mechanism predominantly comprising a catch and a pawl, and with an emergency activation handle, the procedure comprising:
moving the locking mechanisms into its pre-ratchet position thereby activating the emergency activation handle.

11. Motor vehicle door latch according to claim 2, wherein the emergency activation handle is transferred into a position which can be activated by the operator dependent on the sensor signal.

12. Motor vehicle door latch according to claim 1, wherein the activatable position of the emergency activation handle can correspond to a position accessible via a cover.

13. Motor vehicle door latch, according to claim 7, wherein the emergency activation handle is arranged on or near a motor vehicle door.

14. Motor vehicle door latch according to claim 8, wherein the emergency activation handle is designed for striking with two hands.

15. Motor vehicle door latch according to claim 9, wherein positional information of the emergency activation handle encompasses a signal color.

16. Motor vehicle door latch according to claim 9, wherein positional information of the emergency activation handle encompasses a light.
